(19) United States
(12) Patent Application Publication
(10) Pub. No.: US 2015/0292586 A1
(43) Pub. Date: Oct. 15, 2015

(54) Elasticity-Adjustable Nonlinear Pressure Spring Unit

(71) Applicant: GUANGDONG ZHENGMEI FURNITURE TECHNOLOGY CO.,LTD, Dongguan, Guangdong (CN)

(72) Inventors: Xiangqian Li, Dongguan (CN); Qianan Li, Dongguan (CN)

(21) Appl. No.: 14/436,849

(22) PCT Filed: Apr. 3, 2013
(86) PCT No.: PCT/CN2013/073758

§ 371 Date: Apr. 17, 2015

(30) Foreign Application Priority Data
Oct. 19, 2012 (CN) 201210401376.4

(51) Int. Cl. F16F 1/12; F16F 13/00

(52) U.S. Cl. CPC F16F 1/121; F16F 13/007; F16F 1/128; F16F 2228/08; F16F 2228/066; F16F 2236/04

(57) ABSTRACT

A spring unit includes a compressive spring, a reciprocating unit, and a connecting device provided on an upper end of the compressive spring. The reciprocating unit includes a base, a supporting frame movably supported on the base, and a pulling string. The pulling string has an upper end connected to the connecting device, and a lower end extended to connect to the base, and extends along a central space of the compressing spring and penetrating the supporting frame to connect between the connecting device and the base for normally exerting a predetermined downward force to the upper end of the compressive spring. The compressive spring is normally and slightly compressed by a pre-compression force exerted by the pulling string, so that when the compressive spring is subject to an external force, an extension of the compressive spring is non-linear and not directly proportional to the external force.

### BACKGROUND OF THE PRESENT INVENTION

1. Field of Invention

The present invention relates to a spring unit, and more particularly to a spring unit which is capable of providing adjustable and nonlinear elasticity.

2. Description of Related Arts

Spring units have widely been utilized in various fields throughout the world. The question of how to control and achieve an optimal elasticity for the spring units directly affects the range of applications of the spring units. Different products have different requirements in elasticity and this depends on the circumstances in which the product operate. As a result, there is a need to have a spring unit which is capable of achieving adjustable elasticity.

### SUMMARY OF THE PRESENT INVENTION

An objective of the present invention is to provide spring unit which is capable of providing adjustable and nonlinear elasticity. This is accomplished by providing a reciprocating unit and a pulling string which are coupled to a compressive spring for altering an elasticity performance thereof

In one aspect of the present invention, the present invention provides:

a spring unit, comprising a compressive spring, a reciprocating unit provided underneath the compressive spring, and a connecting device provided on an upper end of the compressive spring, the reciprocating unit comprising a base, a supporting frame movably supported on the base, and a pulling string, the pulling string having an upper end connected to the connecting device, and a lower end extended to connect to the base, and extending along a central space of the compressing spring and penetrating the supporting frame to connect between the connecting device and the base for normally exerting a predetermined downward force to the upper end of the compressive spring, so that the compressive spring being normally and slightly compressed by a pre-compression force exerted by the pulling string, wherein when the compressive spring is subject to an external force, an extension of the compressive spring is non-linear and not directly proportional to the external force.

When the reciprocating device is driven to move upwardly, the lower end of the compressive spring is pushed to move upwardly, the pulling string being stretched to exert a tension as a pre-compression force to pre-compress the compressive spring, wherein when the reciprocating device is driven to move downwardly, the lower end of the compressive spring is slightly released to move downwardly, the pulling string being slightly released so that the pre-compression force exerted to the compressive spring is be slightly decreased.

When the compressive spring is subject to external force, a relationship between the extension of the compressive spring and the external force is not linear, when the external force is smaller than the pre-compression force of the pulling string, the compressive spring does not deform, when the external force is larger than the pre-compression force, the compressive spring is extended or compressed in proportional to the external force.

The reciprocating device comprises a plurality of compressive springs and a plurality of supporting frames, which are configured as follows:

(1) when the supporting frame has a relatively large top surface, the compressive springs are mounted on the supporting frame;

(2) the spring unit further comprising a coupling device provided between the compressive spring and the supporting frame wherein the compressive springs and the supporting frames are attached on the coupling device for enabling synchronized movement of the supporting frames and the compressive springs;

(3) the spring unit further comprising a plurality of coupling devices so that each compressive springs are attached on the coupling devices respectively, the coupling devices are connected to the supporting frames respectively so that each of the supporting frames is capable of moving at different attitudes for compressing the compressive springs at different levels.

The reciprocating device comprising a wide variety of structures, which include:

(1) the reciprocating device is embodied as a piston assembly which comprises the base and the supporting frame received in the base to divide the base into a upper compartment and a lower compartment, the reciprocating device further comprising a guiding valve and a connecting pipe connected to the base for allowing a predetermined amount of fluid to be filled in the base;

when the guiding valve is configured such that the fluid is filled in the upper compartment of the base, the supporting frame is driven to move upwardly with respect to the base so as to pre-compress the compressive spring by a pre-compression force, when the guiding valve is configured such that the fluid is filled in the lower compartment of the base, the supporting frame is driven to move downwardly with respect to the base so as to reduce a predetermined amount of the pre-compression force from the compressive spring, when the guiding valve stops working, the fluid stops flowing in and out of the base, the supporting frame being retained in position in the base;

(2) the base and the supporting frame are configured as a nut unit and a screw respectively;

the reciprocating device is arranged to move vertically with respect to the base through rotation of the screw with respect to the nut unit;

(3) the reciprocating device comprises at least two structural components;

the reciprocating device is arranged to move vertically with respect to the base through external force.

The advantages of the present invention is as follows: when the reciprocating device is driven to move upwardly, the lower end of the compressive spring is pushed to move upwardly, the pulling string being stretched to exert a tension as a pre-compression force to pre-compress the compressive spring, wherein when the reciprocating device is driven to move downwardly, the lower end of the compressive spring is slightly released to move downwardly, the pulling string being slightly released so that the pre-compression force exerted to the compressive spring is be slightly decreased. A user is able to conveniently adjust the elasticity of the spring unit by operating on the reciprocating device so as to facilitate widespread applications of the present invention in different fields.

### BRIEF DESCRIPTION OF THE DRAWINGS

FIG. 1 is a first schematic diagram of a spring unit according to a preferred embodiment of the present invention.

FIG. 2 is a second schematic diagram of the spring unit according to the preferred embodiment of the present invention.

FIG. 3 is a graph showing nonlinear property of the spring unit according to the preferred embodiment of the present invention.

In which, 1 refers to compressive spring, 2 refers to connecting device, 3 refers to pulling string, 4 refers to supporting frame, 5 refers to base, 6 refers to guiding valve, and 7 refers to connecting pipe.

### DETAILED DESCRIPTION OF THE PREFERRED EMBODIMENT

### Embodiment

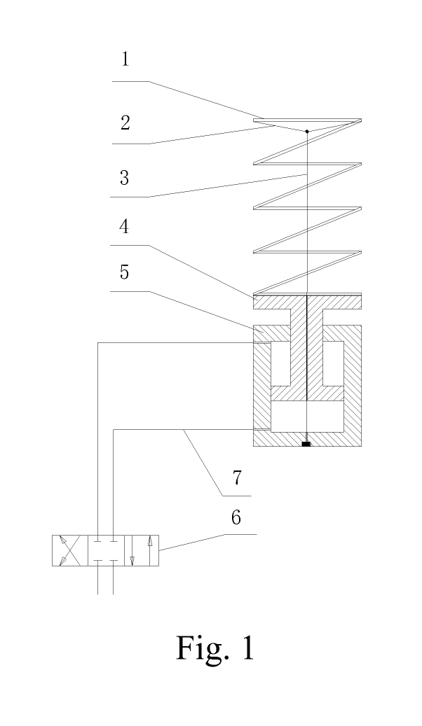

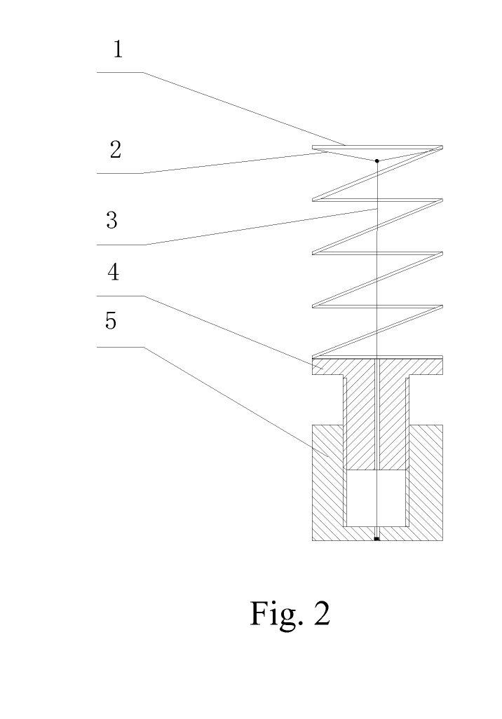

Referring to FIG. 1 to FIG. 2 of the drawings, a spring unit comprises a compressive spring 1 and a reciprocating unit provided underneath the compressive spring 1, a connecting device 2 provided on an upper end of the compressive spring 1. The reciprocating unit comprises a base 5 and a supporting frame 4 movably supported on the base 5. The compressive spring 1 has a lower end connected to the supporting frame 4 in such a manner that when the supporting frame 4 is driven to move with respect to the base 5, the lower end of the compressive spring 1 is also driven to move. The spring unit further comprises a pulling string 3 having an upper end connected to the connecting device 2, and a lower end extended to connect to the base 5. Thus, the pulling string 3 extends along a central space of the compressing spring 1 and penetrates the supporting frame 4 to connect between the connecting device 2 and the base 5 for normally exerting a predetermined downward force to the upper end of the compressive spring 1. As a result, the compressive spring 1 is normally and slightly compressed by the pulling string 3. This configuration ensures that when the compressive spring 1 is subject to external force, the extension of the compressive spring will not be directly proportional to the external force. That is to say, the relationship between the extension of the compressive spring 1 and the external force will not be linear.

The supporting frame 4 is arranged to be selectively moved upwardly and downwardly with respect to the base 5. At default position, the supporting frame 4 is moved so that the pulling string 3 is slightly extended such that it exerts a slight compressive force toward the compressive spring 1 so as to slightly pre-compresses the compressive spring 1 from its equilibrium position. When the supporting frame 4 moves upwardly with respect to the base 5, the lower end of the compressive spring 1 also moves upwardly. This increases the compressive tension exerted by the pulling string 3 so as to further compress the compressive spring 1, and this increases the tension of the compressive spring 1. On the other hand, when the supporting frame 4 moves downwardly with respect to the base 5, the pulling string 3 is slightly extended so as to reduce the force exerted to the compressive spring 1. The result is that the tension of the compressive spring 1 decreases accordingly. With the above configuration, when the compressive spring 1 is subject to external compressive or stretching force, the relationship between the extension of the compressive spring 1 and the external force will not be linear. Specifically, when the external force is smaller than the pre-compression force of the pulling string 3, the compressive spring 1 will not deform. It is only when the external force is larger than the pre-compression force that the compressive spring 1 will be extended or compressed in proportional to the external force.

The connection between the supporting frame 4 and the compressive spring 1 may be embodied as having various configurations as described below:

First alternative: when the supporting frame 4 has a relatively large top surface, more than one compressive spring 1 may be mounted on the supporting frame 4.

Second alternative: the spring unit further comprises a coupling device provided between the compressive spring 1 and the supporting frame 4 wherein more than one compressive spring 1 and more than one supporting frame 4 may be attached on the coupling device. The configuration enables synchronized movement of several supporting frames 4 and the compressive springs 1.

Third alternative: the third alternative is similar to the second alternative except there may be a plurality of coupling devices so that each compressive spring may be attached on the corresponding coupling device which is then connected to the corresponding supporting frame 4. As such, each of the supporting frames 4 may move at different attitude for compressing the compressive springs 1 at different levels or degrees.

The reciprocating device may be embodied as having various configurations as described below:

First configuration: the reciprocating device is embodied as a piston assembly which comprises the base 5 and the supporting frame 4 received in the base 5 to divide the base 5 into a upper compartment and a lower compartment, wherein the reciprocating device further comprises a guiding valve 6 and a connecting pipe 7 connected to the base 5 for allowing a predetermined amount of fluid, such as air, to be filled in the base 5. The base has an interior cavity while the supporting frame 4 is configured as a piston. When the guiding valve 6 is configured such that fluid is filled in the upper compartment of the base 5, the supporting frame 4 is driven to move upwardly with respect to the base 5 so as to pre-compress the compressive spring 1. Conversely, when the guiding valve 6 is configured such that fluid is filled in the lower compartment of the base 5, the supporting frame 4 is driven to move downwardly with respect to the base 5 so as to release a predetermined amount of the pre-compression force from the compressive spring 1. When the guiding valve 6 stops working, the fluid will stop flowing in or out of the base 5. At this moment, the supporting frame 4 may be retained in position in the base 5 for maintaining compression status of the compressive spring 1. Moreover, the gaps between the pulling string 3 and the supporting frame 4 and the base 5 may be sealed for preventing fluid from escaping through these gaps.

Second configuration: the base 5 and the supporting frame 4 may be configured as a nut unit and a screw respectively, wherein the screw is movably engaged with the nut unit in such a manner that when the screw is driven to rotate, the screw will move upwardly or downwardly for moving the lower end of the compressive spring 1 to move in a corresponding direction so as to adjust the pre-compression force of the compressive spring 1.

Third configuration: the reciprocating device comprises at least one base 5 and one supporting frame 4.

The supporting frame 4 is movably connected to the base 5 in such a manner that the supporting frame 4 may be upwardly or downwardly moved with respect to the base 5 so as to adjust the pre-compression force exerted to the compressive spring 1.

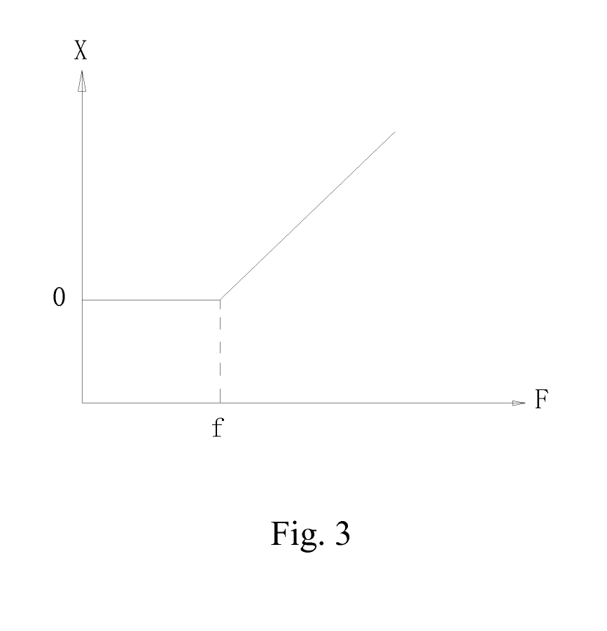

Referring to FIG. 3 of the drawings, the operation of the present invention is as follows: when the supporting frame 4 of the reciprocating device moves upwardly, the lower end of the compressive spring 1 is pushed to move upwardly. The pulling string 3 is then stretched so that the tension pre-compresses the compressive spring 1. When the supporting frame 4 of the reciprocating device moves downwardly, the lower end of the compressive spring 1 is also released to move upwardly. The pulling string 3 is then slightly released so that the pre-compression force exerted to the compressive spring 1 will be slightly decreased. With the above configuration, when the compressive spring 1 is subject to external compressive or stretching force F, the relationship between the extension X of the compressive spring 1 and the external force will not be linear. Specifically, when the external force F is smaller than the pre-compression force f of the pulling string 3, the compressive spring 1 will not deform. X is zero. It is only when the external force F is larger than the pre-compression force f that the compressive spring 1 will be extended or compressed in proportional to the external force. That is, X will be greater than 0.

The present invention, while illustrated and described in terms of a preferred embodiment and several alternatives, is not limited to the particular description contained in this specification. Additional alternatives or equivalent components could also be used to practice the present invention.

What is claimed is:

1. A spring unit, comprising a compressive spring, a reciprocating unit provided underneath said compressive spring, and a connecting device provided on an upper end of said compressive spring, said reciprocating unit comprising a base, a supporting frame movably supported on said base, and a pulling string, said pulling string having an upper end connected to said connecting device, and a lower end extended to connect to said base, and extending along a central space of said compressing spring and penetrating said supporting frame to connect between said connecting device and said base for normally exerting a predetermined downward force to said upper end of said compressive spring, so that said compressive spring being normally and slightly compressed by a pre-compression force exerted by said pulling string, wherein when said compressive spring is subject to an external force, an extension of said compressive spring is non-linear and not directly proportional to said external force.

2. The spring unit, as recited in claim 1, wherein when said reciprocating device is driven to move upwardly, said lower end of said compressive spring is pushed to move upwardly, said pulling string being stretched to exert a tension as a pre-compression force to pre-compress said compressive spring, wherein when said reciprocating device is driven to move downwardly, said lower end of said compressive spring is slightly released to move downwardly, said pulling string being slightly released so that said pre-compression force exerted to said compressive spring is be slightly decreased.

3. The spring unit, as recited in claim 1, wherein when said compressive spring is subject to external force, a relationship between said extension of said compressive spring and said external force is not linear, when said external force is smaller than said pre-compression force of said pulling string, said compressive spring does not deform, when said external force is larger than said pre-compression force, said compressive spring is extended or compressed in proportional to said external force.

4. The spring unit, as recited in claim 1, wherein said reciprocating device comprises a plurality of compressive springs and a plurality of supporting frames, which are configured as follows:
(1) when said supporting frame has a relatively large top surface, said compressive springs are mounted on said supporting frame;
(2) said spring unit further comprising a coupling device provided between said compressive spring and said supporting frame wherein said compressive springs and said supporting frames are attached on said coupling device for enabling synchronized movement of said supporting frames and said compressive springs;
(3) said spring unit further comprising a plurality of coupling devices so that each compressive springs are attached on said coupling devices respectively, said coupling devices are connected to said supporting frames respectively so that each of said supporting frames is capable of moving at different attitudes for compressing said compressive springs at different levels.

5. The spring unit, as recited in claim 1, wherein said reciprocating device comprising a wide variety of structures, which include:
(1) said reciprocating device is embodied as a piston assembly which comprises said base 5 and said supporting frame 4 received in said base 5 to divide said base 5 into a upper compartment and a lower compartment, said reciprocating device further comprising a guiding valve and a connecting pipe connected to said base for allowing a predetermined amount of fluid to be filled in said base;
(2) said base and said supporting frame are configured as a nut unit and a screw respectively;
(3) said reciprocating device comprises at least two structural components.

6. The spring unit, as recited in claim 1 or claim 5, characterized in that:
(1) when said guiding valve is configured such that said fluid is filled in said upper compartment of said base, said supporting frame is driven to move upwardly with respect to said base so as to pre-compress said compressive spring by a pre-compression force, when said guiding valve is configured such that said fluid is filled in said lower compartment of said base, said supporting frame is driven to move downwardly with respect to said base so as to reduce a predetermined amount of said pre-compression force from said compressive spring, when said guiding valve stops working, said fluid stops flowing in and out of said base, said supporting frame being retained in position in said base;
(2) said reciprocating device is arranged to move vertically with respect to said base through rotation of said screw with respect to said nut unit;
(3) said reciprocating device is arranged to move vertically with respect to said base through external force.
